(19) United States
(12) Patent Application Publication
(10) Pub. No.: US 2014/0052500 A1
(43) Pub. Date: Feb. 20, 2014

(54) METHOD AND SYSTEM FOR MANAGING SUSTAINABILITY GOALS OF AN ORGANIZATION

(71) Applicant: Infosys, Limited, Bangalore (IN)

(72) Inventors: Ananthalakshmi Venkatasubramanian Vallapuzha, Bangalore (IN); Lavanya Subramanian, Bangalore (IN)

(73) Assignee: Infosys Limited, Bangalore (IN)

(21) Appl. No.: 13/969,454

(22) Filed: Aug. 16, 2013

(30) Foreign Application Priority Data
Aug. 16, 2012 (IN) 3379/CHE/2012

(51) Int. Cl. G06Q 10/06

(52) U.S. Cl. CPC G06Q 10/0637
USPC 705/7.36

(57) ABSTRACT

The present disclosure discloses an embodiment for managing sustainability goals of an organization. Organizational activities associated with the sustainability goals and performed in the organization are identified. The attributes of the stakeholders of the organization are identified. A first set of activities from the plurality of organizational activities and a second set of activities associated with each of the stakeholders of the organization are determined. Based on the one or more attributes, the first set of activities and the second set of activities, a first sustainability goal to the stakeholders of the organization is assigned. Further, a first set of data corresponding to the first set of activities, a second set of data corresponding to the second set of activities associated with each of the stakeholders are extracted. Based on the first set of data and the second set of data for each of the stakeholders, a personal sustainability index is determined.

### RELATED APPLICATION DATA

This application claims priority to India Patent Application No. 3379/CHE/2012, filed Aug. 16, 2012, the disclosure of which is hereby incorporated by reference in its entirety.

### FIELD OF THE INVENTION

The present disclosure relates to managing sustainability goals of an organization. In particular, the invention relates to assigning sustainability goals among stakeholders of an organization and calculating different sustainability indexes.

### BACKGROUND

Sustainability for an organization has become an integral part of its business function. Sometimes due to government policies and regulations, organizations have to mandatorily incorporate sustainability goals in their business. At times, organizations also willingly involve themselves in sustainability activities to represent it as a responsible corporate citizen, and improve its brand image.

Generally, most of the organizations create a group of people dedicated to perform sustainability activities for that organization. If sustainability has to permeate all elements of business, then the stakeholders of the organization need to be fully aware of sustainability goals and should be bought into the idea of sustainability so that they can implement it in the work they do.

Therefore, there is a need for imbibing the sustainability goal in all business function of an organization so that the stakeholders of the organization can be engaged to participate in different sustainability activities.

### SUMMARY

The present disclosure discloses an embodiment for managing sustainability goals of an organization. Organizational activities associated with the sustainability goals and performed in the organization are identified. The attributes of the stakeholders of the organization are identified. A first set of activities from the plurality of organizational activities and a second set of activities associated with each of the stakeholders of the organization are determined. Based on the one or more attributes, the first set of activities and the second set of activities, a first sustainability goal to the stakeholders of the organization is assigned.

Further, a first set of data corresponding to the first set of activities, a second set of data corresponding to the second set of activities associated with each of the stakeholders are extracted. Based on the first set of data and the second set of data for each of the stakeholders, a personal sustainability index is determined.

In an embodiment, organization sustainability index is determined based on the first set of data and second set of data associated with the stakeholders. Further, a unit sustainability index may also be determined based on the first set of data and second set of data associated with a set of stakeholders.

In another embodiment, reports may be created based on the first set of data, the second set of data, the first set of activities and the second set of activities.

### BRIEF DESCRIPTION OF THE DRAWINGS

FIG. 1 is an illustrative process depicting a manner for managing sustainability goal for an organization.

FIG. 2 illustrates a process for determining a personal sustainability index.

FIG. 3 illustrates an embodiment showing the different sustainability goals of an organization.

FIG. 4 is an embodiment illustrating the details of a stakeholder's personal sustainability goals.

FIG. 5 is an embodiment illustrating sustainability index for a stakeholder, a unit and an organization.

FIG. 6 is a system illustrating a generalized computer network arrangement, in one embodiment of the present technique.

### DETAILED DESCRIPTION

The following description is the full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings. While the invention described herein is provided with a certain degree of specificity, the present technique may be implemented with either greater or lesser specificity, depending on the needs of the user. Further, some of the features of the present technique may be used to get an advantage without the corresponding use of other features described in the following paragraphs. As such, the present description should be considered as merely illustrative of the principles of the present technique and not in limitation thereof.

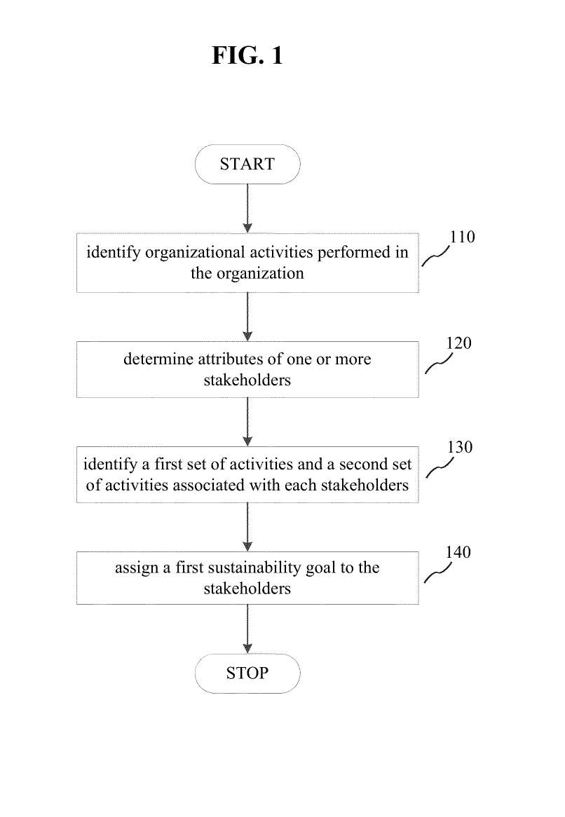

FIG. 1 is an illustrative process depicting the manner for managing sustainability goal for an organization. An organization may involve its stakeholders in meeting its sustainability goals. To enable the stakeholders of the organization in meeting the sustainability goals, the organization needs to assign some of its sustainability goals among the stakeholders. In general, FIG. 1 illustrates steps for managing sustainability goal for an organization. In step 110, organizational activities related to sustainability and performed in the organization are identified. These organizational activities may include, but not limited to, environmental activities such as business travel, water usage, electricity usage, paper usage, raw materials used, fuel usage and procurement of goods; social activities such as education related initiative, disaster relief initiative, health related initiative and any other community development initiative; knowledge management activities such as trainings attended, training material prepared and sustainability level achieved.

At step 120, identify the stakeholders to whom some of the sustainability goals are to be assigned and determine their attributes. As used herein, stakeholders generally refer to individuals associated with the organization such as employees, partners, board of members etc. Attributes of a stakeholder may include, but not limited to, organizational attributes such as nature of work, working hours, relevance to work, level or position in the organization, years of experience, country, region and locality of operation; personal attributes such as skillset, history of performance and health of the employee; preferential parameters include personal interests, choice of activity, choice of location.

At step 130, identify a first set of activities and a second set of activities associated with a stakeholder of the organization. First set of activities herein refer to the activities among the organization activities related to sustainability and which are further associated with the stakeholder. Second set of activities herein refer to the activities not assigned by the organization but the stakeholder has voluntarily initiated and planned to perform or performed. These activities may include but not limited to any of the social activities, environmental activities, any knowledge management or innovation related activities like ideas provided, ideas implemented, suggestions provided.

At step 140, a first sustainability goal is assigned to the stakeholders of the organizations based on the attributes of the stakeholders, the first set of activities and the second set of activities. First sustainability goal may refer to either a portion or whole of the sustainability goals of the organization that are assigned to the stakeholders. For example, say one of the sustainability goals of the organization is to reduce 5% of paper usage in a year. The 5% reduction in paper usage in the organization may be accounted to 10,000 papers less to be used in a year. This sustainability goal will be assigned to different stakeholders depending on different activities they are associated with and their attributes. If a stakeholder prepares lot of product manuals and other stakeholder is a code developer and both have used 1000 papers in last year, then the stakeholder who prepares lot of product manuals might be given a sustainability goal of reducing paper usage by 100 papers while the code developer might be given the sustainability goal of reducing paper usage by 500 papers in a year based on who has the capacity to control and influence change. Therefore, the sustainability goals assigned to the stakeholders here are the first sustainability goal referred herein. Each sustainability goal assigned may be in one or more of plurality of areas like resource consumption (includes but not limited to paper, water, energy, fuel usage, travel miles), waste generation (includes but not limited to bio-degradable, bio-non degradable, raw materials), recycling and reusing (water, waste, materials), procurement of goods (local produce, eco-friendly products), CO2 emissions and social initiatives (number of initiatives volunteered, initiated, implemented, total effort spent) based on first set of activities and one or more attributes of stakeholder. In one embodiment, skilled person in the art may appreciate that the sustainability goal may be assigned to a stakeholder based on the analysis/data mining performed on the data underlying his system.

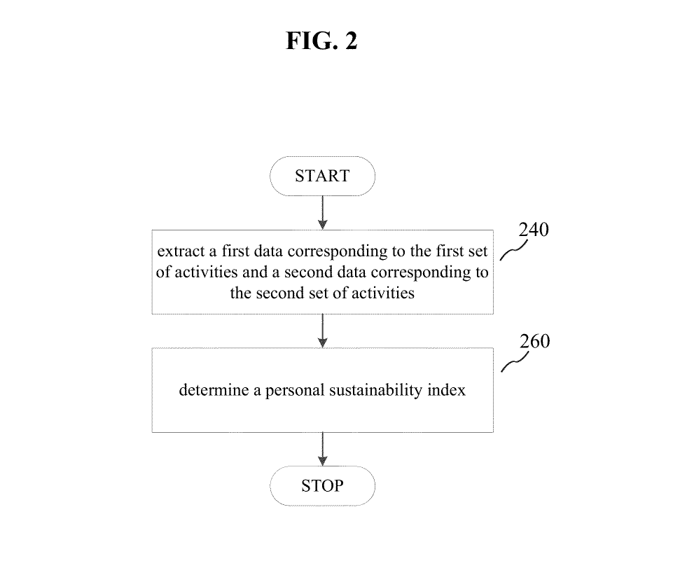

FIG. 2 illustrates a process for determining a personal sustainability index. After the sustainability goals being assigned to the stakeholders, the stakeholders can perform either the first set of activities or the second set of activities or the combination thereof to meet the sustainability goals assigned to them. In one embodiment, the data (hereinafter referred as ‘first set of data’) regarding the first set of activities may be kept on record by the organization. First set of data shall be measured in terms of one or more of (1) resource consumed for activities including but not limited to activities like paper, water, energy, fuel usage, logistics (2) amount of waste generated including bio-degradable, bio-non degradable waste, raw materials waste etc., (3) total amount of water, waste, materials recycled or reused (4) procurement of goods measured in terms of percentage of local produce and eco-friendly products procured (5) social activities measured in terms of number of initiatives volunteered, initiated, implemented, impact to organization, total effort spent, total monetary contributions etc., (6) total CO2 emissions from aforementioned activities based on the sustainability goals assigned to the stakeholder.

The data (hereinafter referred as ‘second set of data’) regarding the second set of activities may be provided by the stakeholder itself. Second set of data shall be measured for voluntary activities not assigned by the organization. In addition to that, number of ideas provided, implemented, innovations achieved, alignment/relevance to organization's goals, cost saved, emissions reduced shall be included.

At step 240, to calculate a personal sustainability index, data corresponding to the first set of activities and the data corresponding to the second set of activities are extracted. At step 260, a personal sustainability index is calculated based on first set of data and second set of data. A personal sustainability index herein refers to a sustainability index calculated for an individual stakeholder. To calculate personal sustainability index, points assigned to each activity will be summed up for the individual stakeholder.

In one embodiment, for example, to calculate sustainability index the first step is to calculate carbon emissions using standard emission calculation methodology (emissions caused/emissions reduced or avoided) for all activities that can be measured in terms of emissions. Amount of carbon emissions shall be assigned equivalent point and based on that all emissions will be converted to points. Activities that cannot be measured in terms of carbon emissions like social activities, ideas given shall be assigned equivalent points based on the impact created for the organization, cost savings, alignment/relevance to organization goals and alignment of activity to organization's risk. For example, social activity performed in location were organization anticipates maximum social risk would carry more weightage compared to other activities even if more effort and impact are created in a location were the social risk is less.

When the sustainability index of an individual is calculated then that index shall herein refers as ‘personal sustainability index’. In one embodiment, sustainability index may be calculated for a group of individuals by summing up the sustainability index of the group stakeholders. Such group sustainability index herein refers as ‘unit sustainability index’. In another embodiment, sustainability index may be calculated for the whole organization by summing up the sustainability index of the stakeholders whom the sustainability goal has been assigned. Such sustainability index herein refers to ‘organization sustainability index’. In yet another embodiment, Organization's sustainability goals shall be tracked based on sustainability goals targeted and goals achieved for a given period from the first set of activities assigned to stakeholders. Second set of activities helps the organization to understand what organizations have done beyond business to larger society and environment by enabling a platform for voluntary activities and innovation amongst its stakeholders. Sustainability Index may be measured based on percent sustainability goal achieved against each of its goals. i.e. for example if one of the organization's goal is to reduce emissions by 20% and assuming the reduction achieved is more than the goal, positive points shall be assigned against the specific goal and if the reduction achieved is less than the target, negative points shall be assigned. Similarly goals planned and goals achieved may be compared for all sustainability goals and weighted average of all individual points will give the organization sustainability index.

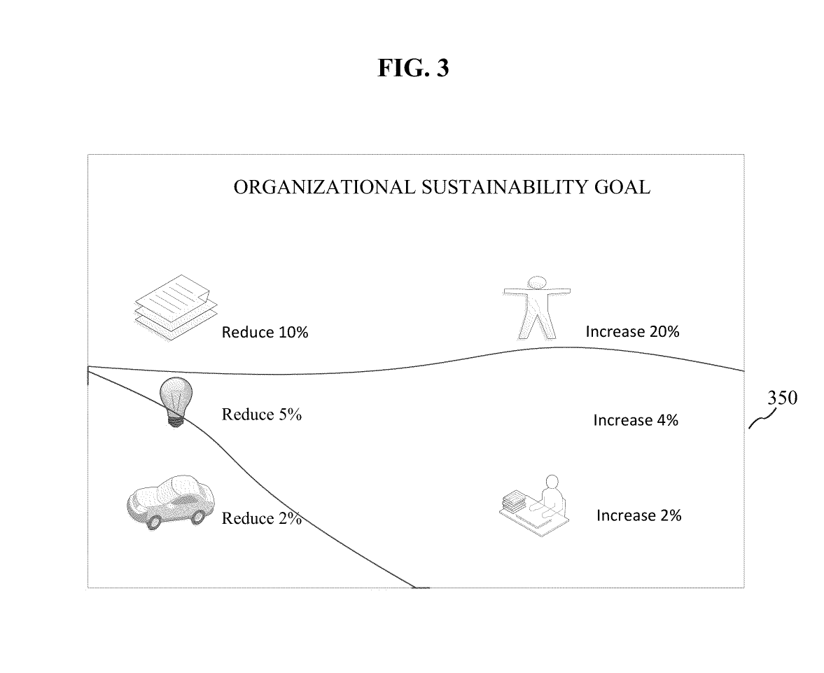

FIG. 3 illustrates an embodiment showing the different sustainability goals of an organization. 350 is a user interface showing different sustainability goals of the organization. For the purpose of illustration, some of the sustainability goals of the organization are shown in the user interface 350 are paper usage to be reduced by 5%, electricity usage to be reduced by 5%, travel activities to be reduced by 2%, health related activities to be increased by 20%, disaster/natural calamity relief to be increased by 4% and sustainability related research activities to be increased by 2%. These are the few sustainability goals shown for the purpose of illustration and as appreciated by a person skilled in art, there can be many other sustainability goals with respect to other activities. In one embodiment, the sustainability goal may be illustrated in other value such as numerical value instead of percentage.

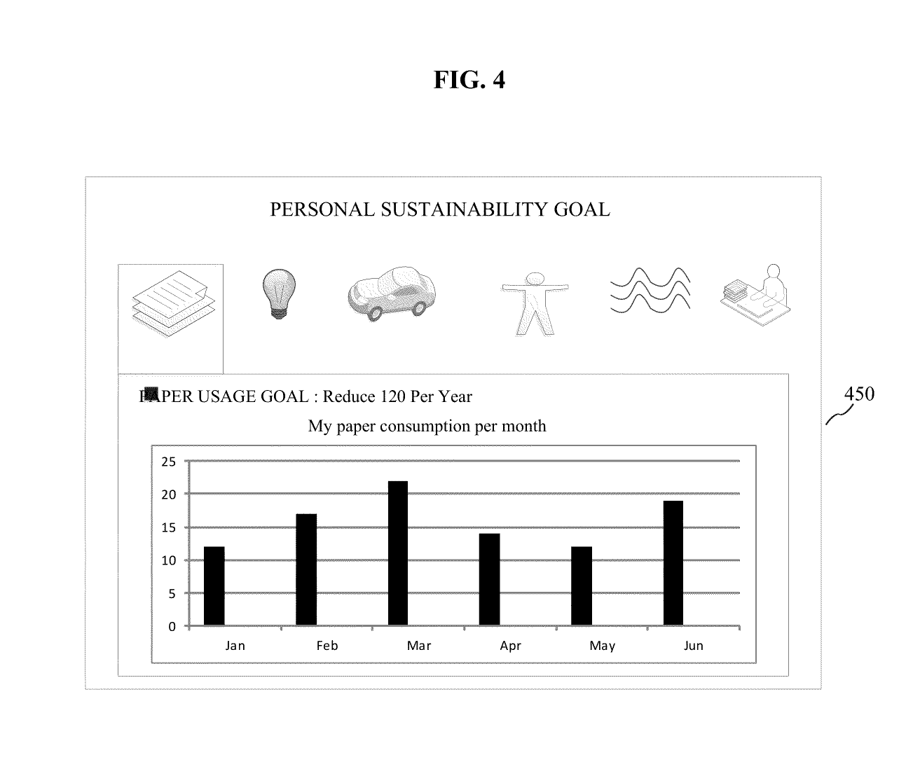

FIG. 4 is an embodiment illustrating the details of a stakeholder's personal sustainability goals. 450 is a user interface showing details of a stakeholder's personal sustainability goals. For the purpose of illustration, the user interface 450 shows the paper usage for a stakeholder as 120 less papers per year. The paper usage for the stakeholder may be assigned in percent. Further, the user interface 450 illustrates the usage of paper by the stakeholder from month January to June. The representation of data pertaining to the sustainability goal may in any representation such as graphs, charts etc. Similarly, the stakeholder can see the data pertaining to other different activities and can regulate his activities accordingly. In one embodiment, the stakeholder is enabled to add the voluntary activities he has performed and the data corresponding to it.

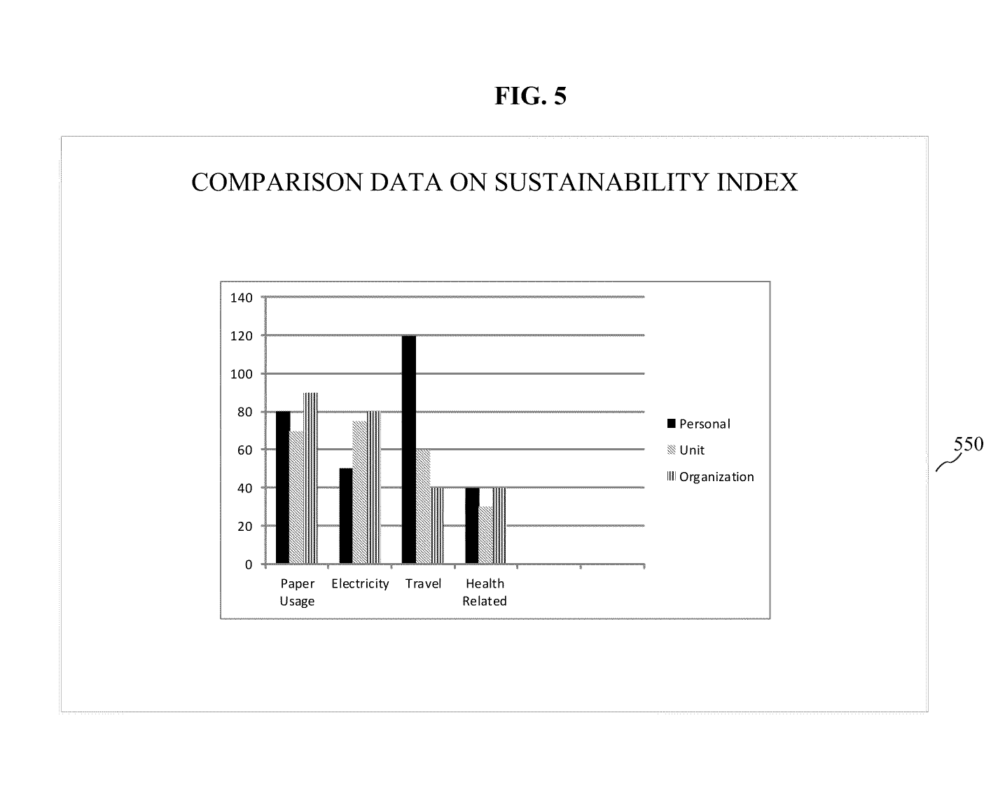

FIG. 5 is an embodiment illustrating sustainability index for a stakeholder, a unit and an organization. 550 is a user interface illustrating a graph between the sustainability goals of an organization such as paper usage, electricity usage, travel activities and health related activities and sustainability index calculated for a stakeholder, a unit and the organization as a whole for a year. The values shown on the y-axis are in percentage for the purpose of illustration. As shown in the graph, in paper usage goal, stakeholder is managed to complete 80% of his goal i.e. if the stakeholder had a goal to reduce the usage of paper by 100 pages then in a year he manages to reduce the usage of the paper by 80 pages. To check the goal of a group of people, in one embodiment, the stakeholder can select a group of people i.e. a unit to see the sustainability index of that group. The values related for unit sustainability index may be a simple average or weighted average of the sustainability index of the individuals in that group. As shown in the graph, a unit sustainability index is 70% that may mean that as a unit, the unit has achieved the goal of paper usage by 70%. Similarly, the organization is shown to have achieved the paper usage goal by 90%. Likewise, a report may also be generated comparing different units or stakeholders with respect to different sustainability goals assigned to respective units and stakeholders. In another embodiment, sustainability index for different stakeholders/unit or the organization can be calculated as a single number using weighted average over the sustainability index of different sustainability goals achieved.

### Exemplary Computing Environment

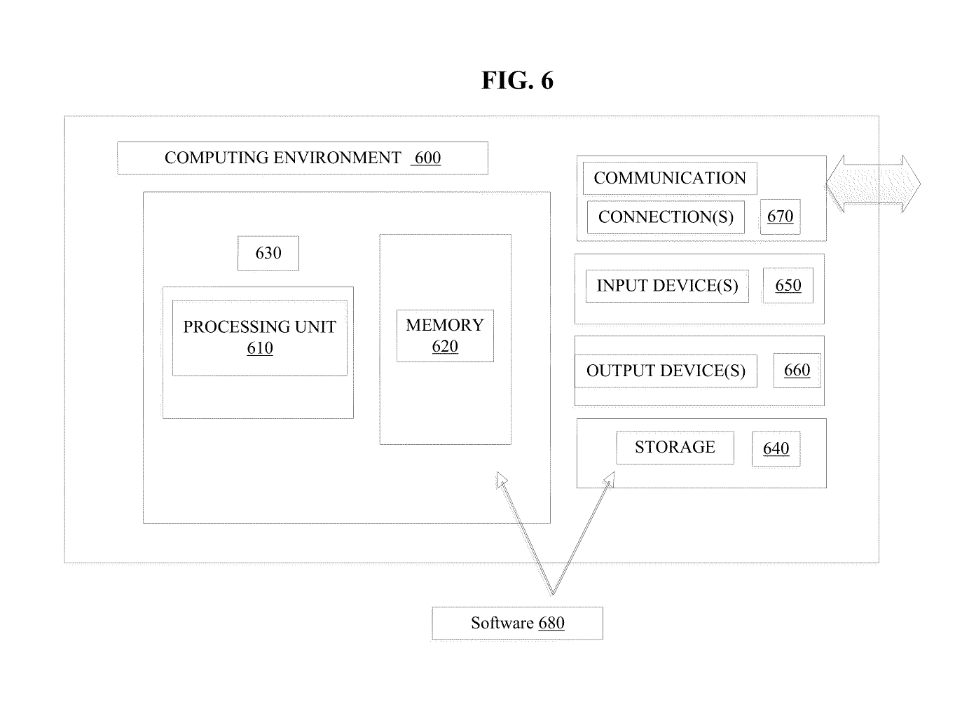

One or more of the above-described techniques may be implemented in or involve one or more computer systems. FIG. 6 illustrates a generalized example of a computing environment 600. The computing environment 600 is not intended to suggest any limitation as to scope of use or functionality of described embodiments.

With reference to FIG. 6, the computing environment 600 includes at least one processing unit 610 and memory 620. In FIG. 6, this most basic configuration 630 is included within a dashed line. The processing unit 610 executes computer-executable instructions and may be a real or a virtual processor. In a multi-processing system, multiple processing units execute computer-executable instructions to increase processing power. The memory 620 may be volatile memory (e.g., registers, cache, RAM), non-volatile memory (e.g., ROM, EEPROM, flash memory, etc.), or some combination of the two. In some embodiments, the memory 620 stores software 680 implementing described techniques.

A computing environment may have additional features. For example, the computing environment 600 includes storage 640, one or more input devices 650, one or more output devices 660, and one or more communication connections 670. An interconnection mechanism (not shown) such as a bus, controller, or network interconnects the components of the computing environment 600. Typically, operating system software (not shown) provides an operating environment for other software executing in the computing environment 600, and coordinates activities of the components of the computing environment 600.

The storage 640 may be removable or non-removable, and includes magnetic disks, magnetic tapes or cassettes, CD-ROMs, CD-RWs, DVDs, or any other medium which may be used to store information and which may be accessed within the computing environment 600. In some embodiments, the storage 640 stores instructions for the software 1080.

The input device(s) 650 may be a touch input device such as a keyboard, mouse, pen, trackball, touch screen, or game controller, a voice input device, a scanning device, a digital camera, or another device that provides input to the computing environment 600. The output device(s) 660 may be a display, printer, speaker, or another device that provides output from the computing environment 600.

The communication connection(s) 670 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations may be described in the general context of computer-readable media. Computer-readable media are any available media that may be accessed within a computing environment. By way of example, and not limitation, within the computing environment 600, computer-readable media include memory 620, storage 640, communication media, and combinations of any of the above.

Having described and illustrated the principles of our invention with reference to described embodiments, it will be recognized that the described embodiments may be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

In view of the many possible embodiments to which the principles of our invention may be applied, we claim as our invention all such embodiments as may come within the scope and spirit of the following claims and equivalents thereto.

What is claimed is:

1. A computer implemented method executed by one or more computing devices for managing sustainability goals of an organization, the method comprises:
retrieving, from the one or more computing devices, a plurality of organizational activities performed in the organization, wherein each of the plurality of activities is associated with the sustainability goals of the organization;
retrieving, from the one or more computing devices, one or more attributes of one or more stakeholders of the organization;
retrieving, from one or more computing devices, a first set of activities from the plurality of organizational activities and a second set of activities associated with each of the one or more stakeholders of the organization; and
assigning a first sustainability goal to the one or more stakeholders of the organization based on the one or more attributes, the first set of activities and the second set of activities.

2. The method of claim 1, further comprising:
extracting from the one or more computing devices, a first set of data corresponding to the first set of activities, a second set of data corresponding to the second set of activities associated with each of the one or more stakeholders;
determining a personal sustainability index based on the first set of data and the second set of data for each of the one or more stakeholders.

3. The method of claim 2, further comprising determining an organization sustainability index based on the first set of data and second set of data associated with the one or more stakeholders.

4. The method of claim 2, further comprising determining a unit sustainability index based on the first set of data and second set of data associated with a set of stakeholders from the one or more stakeholders.

5. The method of claim 2, further comprising creating a plurality of reports based on the first set of data, the second set of data, the first set of activities and the second set of activities.

6. The method of claim 1, wherein the first set of activities and the second set of activities comprise one or more of:
environmental activities;
social activities; and
knowledge management activities.

7. The method of claim 1, wherein the one or more attributes comprise one or more of:
organizational attributes;
personal attributes; and
preferential attributes.

8. A computing device for managing sustainability goals of an organization, the device comprising:
a processor; and
a memory operatively coupled to the processor, the memory storing computer executable instructions which, when executed by the processor, cause the processor to carry out the method comprising:
retrieving, from the one or more computing devices, a plurality of organizational activities performed in the organization, wherein each of the plurality of activities is associated with the sustainability goals of the organization;
retrieving, from the one or more computing devices, one or more attributes of one or more stakeholders of the organization,
retrieving, from one or more computing devices, a first set of activities from the plurality of organizational activities and a second set of activities associated with each of the one or more stakeholders of the organization; and
assigning a first sustainability goal to the one or more stakeholders of the organization based on the one or more attributes, the first set of activities and the second set of activities.

9. The computing device of claim 8, wherein the processor further carry out the method comprising:
extracting from the one or more computing devices, a first set of data corresponding to the first set of activities, a second set of data corresponding to the second set of activities associated with each of the one or more stakeholders; and
determining a personal sustainability index based on the first set of data and the second set of data for each of the one or more stakeholders.

10. The computing device of claim 9, wherein the processor further carry out the method comprising determining an organization sustainability index based on the first set of data and second set of data associated with the one or more stakeholders.

11. The computing device of claim 9, wherein the processor further carry out the method comprising determining a unit sustainability index based on the first set of data and second set of data associated with a set of stakeholders from the one or more stakeholders.

12. The computing device of claim 9, wherein the processor further carry out the method comprising creating a plurality of reports based on the first set of data, the second set of data, the first set of activities and the second set of activities.

13. The computing device of claim 8, wherein the first set of activities and the second set of activities comprises one or more of:
environmental activities;
social activities; and
knowledge management activities.

14. The computing device of claim 8, wherein the one or more attributes comprises one or more of:
organizational attributes;
personal attributes; and
preferential attributes.

15. A computer program product comprising a non-transitory computer readable medium comprising computer readable program code embodied therein for managing sustainability goals of an organization, the method comprises:
retrieving, from the one or more computing devices, a plurality of organizational activities performed in the organization, wherein each of the plurality of activities is associated with the sustainability goals of the organization;
retrieving, from the one or more computing devices, one or more attributes of one or more stakeholders of the organization;
retrieving, from one or more computing devices, a first set of activities from the plurality of organizational activities and a second set of activities associated with each of the one or more stakeholders of the organization; and
assigning a first sustainability goal to the one or more stakeholders of the organization based on the one or more attributes, the first set of activities and the second set of activities.

16. The product of claim 15, further comprising:
extracting from the one or more computing devices, a first set of data corresponding to the first set of activities, a second set of data corresponding to the second set of activities associated with each of the one or more stakeholders; and
determining a personal sustainability index based on the first set of data and the second set of data for each of the one or more stakeholders.

17. The product of claim 15, further comprising determining an organization sustainability index based on the first set of data and second set of data associated with the one or more stakeholders.

18. The product of claim 15, further comprising determining a unit sustainability index based on the first set of data and second set of data associated with a set of stakeholders from the one or more stakeholders.

19. The product of claim 15, further comprising creating a plurality of reports based on the first set of data, the second set of data, the first set of activities and the second set of activities.

20. The product of claim 15, wherein the first set of activities and the second set of activities comprises one or more of:
environmental activities;
social activities; and
knowledge management activities.

21. The product of claim 15, wherein the one or more attributes comprises one or more of:
organizational attributes;
personal attributes; and
preferential attributes.
